(19) United States
(12) Patent Application Publication
(10) Pub. No.: US 2008/0011660 A1
(43) Pub. Date: Jan. 17, 2008

(54) Bottled Liquid Dispensers

(76) Inventor: Philip Andrew Walton, Bishop Auckland (GB)

Correspondence Address: Law Office of Ira S. Dorman, 330 Roberts Street, Suite 200, East Hartford, CT, 06108, US

(21) Appl. No.: 11/630,048

(22) PCT Filed: Jan. 12, 2006
(86) PCT No.: PCT/GB05/02572

§ 371 Date: Dec. 18, 2006

(30) Foreign Application Priority Data
Jul. 3, 2004 (GB) 0415014.0

(51) Int. Cl. C02F 1/50

(52) U.S. Cl. 210/209; 210/764

(57) ABSTRACT

Bottled water or other liquid is supplied via a bottle connector 5 for releasable sealing engagement with a neck formed on the bottle, and a transfer tube 6 to a reservoir 7 wherein the water may be cooled. The bottle connector 5, the transfer tube 6 and the reservoir 7 are all moulded of a plastics material and are coated with an organosilicon quaternary ammonium compound which is effective to inhibit the growth of microorganisms on the surface of the components. The bottle connector may include a feed tube 21 or a dip tube which are also coated with the material. Furthermore, the transfer tube 6 may be connected to the reservoir 7 via a reservoir connector 29 which may incorporate a draw tube 31 and one or more outlet tubes 14, 36, e.g. leading to a discharge outlet, all of which have a similar antimicrobial coating.

### TECHNICAL FIELD OF THE INVENTION

This invention relates to bottled liquid dispensers of the kind in which a liquid (usually water) is supplied from a bottle to a discharge outlet via a reservoir. Generally (but not always) the liquid is heated or cooled in the reservoir.

### BACKGROUND

In recent years a great deal of attention has been paid to improving hygiene in bottled liquid dispensers, more particularly to prevent the multiplication of bacteria which could cause health problems.

In the past the reservoir and its associated components were fixed in the dispenser and it was necessary to sanitize them in situ during periodic routine maintenance.

FR 2 685 293 A1 proposes to separate the liquid from any air which enters the bottle by sealing the liquid within a separate collapsible bag. However, a more common approach to reducing the risk of contamination with air-borne pathogens is to filter the air before it enters the bottle.

Another sanitizing measure proposed in GB 1 552 559 is to place a porous ceramic body between the bottle and the reservoir. The ceramic body contains metallic silver which it is claimed will disinfect the water as it flows into the reservoir. However, it is doubtful whether such brief contact would achieve effective and lasting sanitization. A more effective approach is disclosed in WO 03 051 780 A (Ebac Limited). The components that come into contact with water are formed of or lined with a material containing silver in a bound form which releases silver ions (Ag+) into the liquid from the surface of the material at a controlled rate. Although this proposal is very effective, the materials which are currently available tend to become less effective with time as the silver ions become depleted.

The most effective solution to date which is the subject of EP 0 581 491 A (Ebac Limited) is to provide a disposable reservoir in combination with a feed tube unit which is releasably supported beneath the bottle for connection therewith so that the feed tube unit, reservoir and interconnecting pipework (known as a Watertrail* assembly) can be periodically removed and replaced with clean components. Although this system is very reliable at minimising the risk of bacterial growth if the Watertrail* assembly is changed at the recommended intervals there is a constant desire to improve the level of hygiene.
Watertrail is a registered trade mark of Ebac Limited. AEGIS is a trade mark of AEGIS Environmental Management, Inc.

The present invention seeks to provide a new and inventive form of liquid dispensing apparatus which provides an even greater increase in hygiene compared with existing apparatus.

### SUMMARY OF THE INVENTION

The present invention proposes a bottled liquid dispenser in which liquid is supplied from a bottle to a discharge outlet via a reservoir, wherein the dispenser includes a bottle connector for releasable sealing engagement with a neck formed on the bottle and conduit means for conducting liquid from the bottle connector to the reservoir, characterised in that at least the bottle connector, the conduit means and the reservoir are coated with an organosilicon quaternary ammonium compound which is effective to inhibit the growth of microorganisms.

By providing such a coating on the internal surfaces of the main components which come into direct contact with the liquid, any microorganisms are attacked at the solid-liquid interface where they are most likely to lodge and multiply.

The conduit means is preferably a flexible transfer tube which connects the bottle connector to a separate reservoir.

The reservoir may be provided with thermal means for controlling the temperature of liquid in the reservoir, either by heating or cooling the liquid.

The bottle connector may take various forms and may incorporate a feed tube arranged to project into the neck of the bottle which is supported with the neck downwards or a dip tube which projects down into a bottle which is supported with its neck upwards. Such a feed tube or dip tube are preferably coated with the antimicrobial material.

The apparatus may further include at least one outlet tube for conducting liquid from the reservoir to the discharge outlet, in which case the or each outlet tube is preferably coated with the material.

The transfer tube and the or each outlet tube is preferably connected with the reservoir via a reservoir connector, and this too is preferably coated with the material. The reservoir connector may incorporate a draw tube which projects into the reservoir for removing liquid therefrom, in which case the draw tube is preferably coated with the material.

### BRIEF DESCRIPTION OF THE DRAWINGS

The following description and the accompanying drawings referred to therein are included by way of non-limiting example in order to illustrate how the invention may be put into practice. In the drawings:

FIG. 1 is a schematic drawing showing the main components of a water cooler in accordance with the invention; and

FIG. 2 is a general view of various components which are incorporated in the water cooler.

### DETAILED DESCRIPTION OF THE DRAWINGS

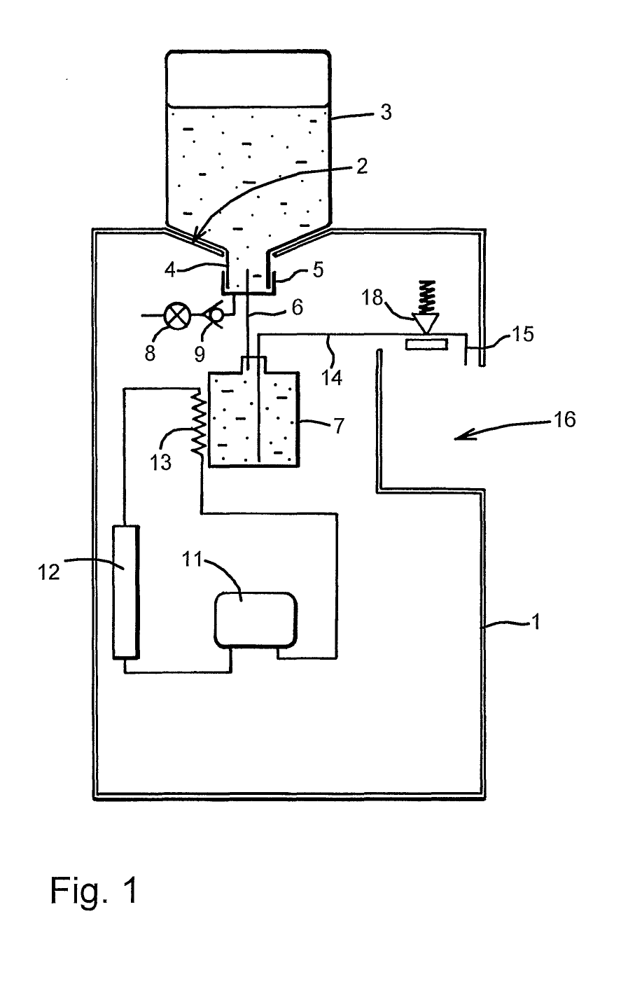

Referring to FIG. 1, the illustrated water cooler includes a housing 1 which is provided with a seat 2 for receiving a water bottle 3 which is mounted in an inverted position with its neck 4 inserted through an aperture in the seat 2. The neck is sealably engaged with a bottle connector 5 which is removably mounted within the housing 1, and from which a transfer tube 6 conducts water from the bottle to a reservoir 7, also removably mounted within the housing. Water displaced from the bottle is replaced by air which enters the bottle connector 5 via a microfilter 8 and a non-return valve 9. Water contained within the reservoir 7 may be cooled by a refrigeration system which includes a compressor 11, an air-cooled condenser 12 and an evaporator 13 which is mounted in close thermal contact with the reservoir 7. Chilled water is removed from the reservoir 7 via an outlet tube 14 which terminates in a discharge outlet 15 disposed above a dispensing recess 16 formed in the housing 1, flow control being achieved by means of a pinch valve 18 which may be as disclosed in patent specification No. EP 0 581 492 A (Ebac Limited).

It will be appreciated that although the water is normally cooled in the reservoir 7, an outlet could be provided for dispensing water at ambient temperature. Furthermore, water could be supplied to a hot tank to be heated and dispensed above ambient temperature, for use in hot beverages for example.

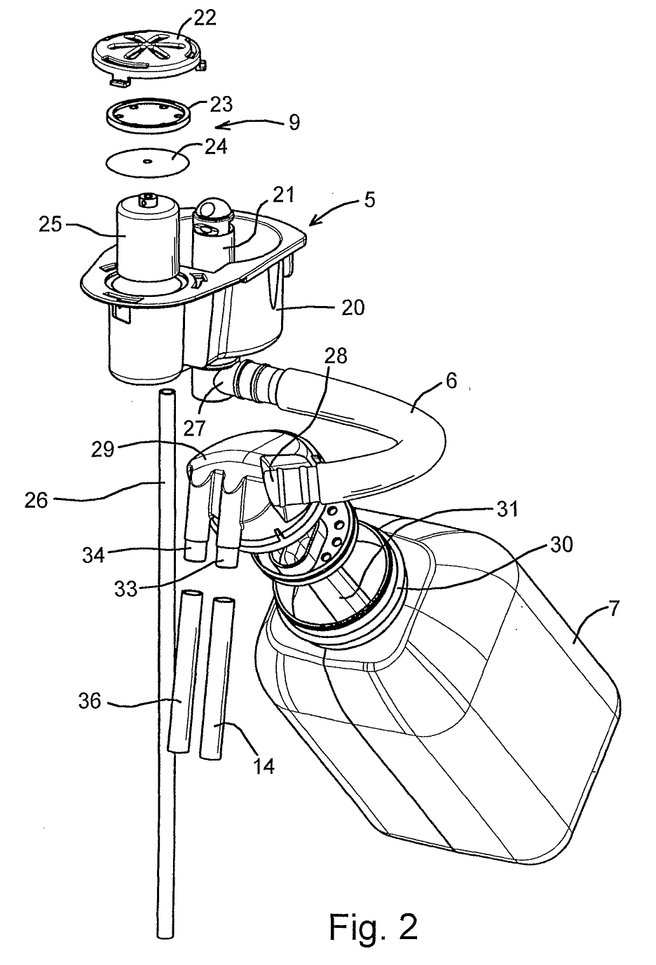

The bottle connector 5, reservoir 7 and tubes 6 and 14 are included in a replaceable Watertrail* assembly which is broadly as described in EP 0 581 491 A (Ebac Limited), and which is shown in more detail in FIG. 2. The connector 5 includes a cup-like manifold body 20, moulded of ABS, which incorporates a feed tube 21 which projects upwardly into the neck of the bottle. The manifold body also incorporates additional components such as the air filter 8 and a one way valve 9, which includes the cap 22, valve seat member 23, silicone valve disc 24 and float 25. Any water leakages are conducted to waste by a drain tube 26. The transfer tube 6, which is moulded of LDPE, connects with a spigot 27 on the bottle connector 5 to conduct water from the feed tube 21 to an inlet spigot 28 formed on a reservoir connector in the form of a cap 29 which is moulded of HDPE. The cap engages with a cylindrical collar 30 formed on the reservoir 7, formed of blown HDPE, which may be received in a heat-insulated receptacle (not shown) incorporating the evaporator 13 (not shown). The cap 29 includes a draw tube unit 31, also of HDPE, through which chilled water can be removed from the lower part of the reservoir 7. The outlet tube 14 is formed of silicone rubber and engages a reservoir outlet spigot 33 formed on the cap 29. A further outlet spigot 34 may be provided on the cap 29 in known manner to conduct water to a hot tank and/or ambient water outlet (not shown) via an ambient outlet tube 36, also of silicone rubber.

The manifold body 20, transfer tube 6, the reservoir cap 29, draw tube unit 31, reservoir 7 and outlet tubes 14 and 36 are all coated with an antimicrobial agent in the form of an organosilicon quaternary ammonium compound which is effective to inhibit the growth of microorganisms. More specifically, the surfaces that come into contact with water are coated with the cationic silane quaternary ammonium salt 3-(trimethoxysilyl)propyldimethyloctadecyl ammonium chloride (Si-QAC). A suitable material is commercially available from AEGIS Environmental Management, Inc. under the trade name AEGIS* Antimicrobial based on Dow Corning AEM 5700. The material is easily applied in aqueous solution, typically 0.1% by weight. The silyl group of the compound attaches itself to the surface of the target substrate, and forms substantially irreversible covalent bonds with the substrate at room temperature within a short period, e.g. ten minutes, establishing a layer of copolymer covering the entire surface. The antimicrobial activity has been attributed to disruption of membrane function at the microbial cell wall, possibly membrane lysis, membrane enzyme inactivation or interference with ion transport. It is believed that the long chain of the hydrocarbon moiety (C₁₈H₃₇) plays an active part, and that the positively charged nitrogen component may also have an independent role. The antimicrobial property of the compound is not reduced over time and remains active for many years.

When the Watertrail* assembly is in use, bacterial, fungi, moulds, algae and yeasts are destroyed on contact with the surface coating. As a result, the Watertrail* assembly is capable of inhibiting microbial growth indefinitely within the treated components, well in excess of the normal period recommended for replacement of the Watertrail* assembly. Although the antimicrobial agent only acts at the component-water interface it will be appreciated that since surface multiplication of microorganisms is prevented the whole system is effectively sanitized for the life of the assembly. In normal use of the dispenser any microorganisms present in the main volume of liquid are carried through the apparatus before they can multiply to a significant level.

Clearly the components which do not come into contact with water which may be ingested need not be treated with the antimicrobial compound. Therefore, the components of the valve assembly 9 and the drain tube 26 can remain untreated.

It should also be noted that although the general form of water cooler described herein is widely used the invention is not limited to such water coolers. For example, the bottle connector can be mounted on a reservoir which is vented to atmosphere. Also, the bottle could be mounted with its neck uppermost, in which case the bottle connector would incorporate a dip tube for removing water from the lower part of the bottle. Water may be displaced by pressurising the air space within the bottle, as described in EP 1 118 582 A2 of Ebac Limited for example.

It will be appreciated that the features disclosed herein may be present in any feasible combination. Whilst the above description lays emphasis on those areas which, in combination, are believed to be new, protection is claimed for any inventive combination of the features disclosed herein.

1. A bottled liquid dispenser in which liquid is supplied from a bottle (3) to a discharge outlet (15) via a reservoir (7), wherein the dispenser includes a bottle connector (5) for releasable sealing engagement with a neck (4) formed on the bottle and conduit means (6) for conducting liquid from the bottle connector to the reservoir,
characterised in that at least the bottle connector (5), the conduit means (6) and the reservoir (7) are coated with an organosilicon quaternary ammonium compound which is effective to inhibit the growth of microorganisms.

2. A bottled liquid dispenser according to claim 1 in which the organosilicon quaternary ammonium compound is applied as a molecular surface coating of copolymer.

3. A bottled liquid dispenser according to claim 1 in which the organosilicon quaternary ammonium compound is 3-(trimethoxysilyl)propyldimethyloctadecyl ammonium chloride.

4. A bottled liquid dispenser according to claim 1 in which the bottle connector (5) incorporates a tube (21) which is arranged to project into the neck (4) of the bottle (3) and which is coated with the organosilicon quaternary ammonium compound.

5. A bottled liquid dispenser according to claim 1 which includes at least one outlet tube (14) for conducting liquid from the reservoir (7) to the discharge outlet (15) and the or each outlet tube is coated with the organosilicon quaternary ammonium compound.

6. A bottled liquid dispenser according to claim 5 in which the conduit means (6) and the or each outlet tube (14) is connected with the reservoir (7) via a reservoir connector (29) which is coated with the organosilicon quaternary ammonium compound.

7. A bottled liquid dispenser according to claim 6 in which the reservoir connector (29) incorporates a draw tube (31) which projects into the reservoir (7) for removing liquid therefrom and the draw tube is coated with the organosilicon quaternary ammonium compound.
